(19) United States
(12) Patent Application Publication
(10) Pub. No.: US 2014/0158291 A1
(43) Pub. Date: Jun. 12, 2014

(54) METHOD FOR MANUFACTURING BONDED MEMBER

(71) Applicant: Origin Electric Company Limited, Tokyo (JP)

(72) Inventors: Takayuki Suzuki, Tokyo (JP); Masahiro Nakamura, Tokyo (JP); Hideyuki Kokaji, Tokyo (JP); Masanobu Nagahama, Tokyo (JP); Kousuke Inaya, Tokyo (JP)

(73) Assignee: Origin Electric Company Limited, Tokyo (JP)

(21) Appl. No.: 14/081,698

(22) Filed: Nov. 15, 2013

(30) Foreign Application Priority Data
Dec. 7, 2012 (JP) 2012-268246

(51) Int. Cl. C09J 5/04

(52) U.S. Cl. CPC C09J 5/04
USPC 156/273.3

(57) ABSTRACT

A method for manufacturing a bonded member is disclosed in which spread of an adhesive between two members can be performed in a short time and manufacturing time of a bonded member can be reduced. A predetermined area of at least either one of bonded surfaces of two members is coated with an adhesive, while a spreading adhesive is applied on at least either one of the bonded surfaces of the two members, and the bonded surfaces of the two members are caused to face each other, the spreading adhesive is brought into contact with the coating adhesive of the other member or the other member, the two members are pressurized so as to spread the spreading adhesive, and the two members are bonded together so as to manufacture a bonded member.

This application claims the benefit of foreign filing priority of Japanese Patent Application No. 2012-268246, filed Dec. 7, 2012, the entire contents of which are incorporated herein by reference.

### BACKGROUND OF THE INVENTION

1. Field of the Invention

The present invention relates to a method for bonding two members together by an adhesive so as to manufacture a bonded member.

2. Description of the Related Art

A method for bonding two members, for example, a liquid crystal panel and protective glass, together by an adhesive so as to manufacture a bonded member includes a pressurizing type in which an adhesive is applied between the two members and they are pressurized so as to spread the adhesive and to bond the members. The pressurizing type method is a method in which, for example, an adhesive is applied on a part of a bonded surface of one of the members, the bonded surfaces of the two members are faced with each other and the adhesive is brought into contact with the other member, the two members are pressurized, and the adhesive is spread (For example, see Japanese Patent Application Laid-Open Publication No. 2010-024321 (for example [0043]).

FIGS. 9A and 9B are explanatory diagrams of a prior-art pressurizing type method for manufacturing a bonded member. As illustrated in FIG. 9A, one of two members 11a and 11b is coated with adhesive 12. FIGS. 9A and 9B illustrate a case in which the adhesive 12 is raised and applied on a part of the surface of the member 11a. Then, the bonded surfaces of the two members 11a and 11b are faced with each other, and as illustrated in FIG. 93, the adhesive 12 is brought into contact with the other member 11b, and the two members 11a and 11b are pressurized so as to spread the raised adhesive 12. Then, the adhesive 12 is spread over the whole surfaces of the two members 11a and 11b.

### SUMMARY OF THE INVENTION

However, the pressurized type method is suitable if the members 11a and 11b to be bonded are small, but if the members 11a and 11b are large, spread of the adhesive 12 takes time. Moreover, the larger friction on an interface between the members 11a and 11b and the adhesive 12 is, the larger viscosity of the adhesive 12 is and moreover, the larger wettability of the adhesive 12 is, the slower the spread of the adhesive becomes. Therefore, with the pressurizing type method, there is a problem that spread time of the adhesive 12 is affected by the sizes of the members 11a and 11b to be bonded or physical values of the adhesive 12, and manufacture of the bonded member takes time.

The present invention has an object to provide a method for manufacturing a bonded member which can spread the adhesive between the two members in a short time and can reduce manufacturing time of the bonded member.

A method for manufacturing a bonded member according to an invention in the first aspect is characterized in that a predetermined area on a bonded surface of at least either one of two members is coated with an adhesive, a spreading adhesive is applied on the bonded surface of at least either one of the two members, the two members are faced with each other while a distance between the bonded surface thereof is kept, a voltage is applied intermittently between the two members, and the adhesive is wetted at a spot on the bonded surface of the other member and then, the spreading adhesive is brought into contact with the coating adhesive of the other member or the other member, the two members are pressurized so as to spread the spreading adhesive, and the two members are bonded so as to manufacture a bonded member.

A method for manufacturing a bonded member according to an invention in the second aspect is characterized in that, in the invention of the first aspect, the predetermined area coated with the adhesive is the whole area of the bonded surface of the member.

A method for manufacturing a bonded member according to an invention in the third aspect is characterized in that, in the invention of the first aspect, the predetermined area coated with the adhesive is an area inside an edge portion of the bonded surface of the member for which a non-coated area required for preventing protrusion of the adhesive is ensured from the edge portion of the member when the two members are pressurized and the spreading adhesive is spread.

According to the invention in the first aspect, the voltage is intermittently applied between the bonded surfaces of the members, the adhesive is wetted at a spot on the bonded surface of the other member and then, the spreading adhesive is brought into contact with the coating adhesive of the other member or the other member, the two members are pressurized so as to spread the spreading adhesive, and thus, the spread of the spreading adhesive is promoted. Therefore, the spread of the adhesive between the two members can be performed in a short time, manufacturing time of the bonded member can be reduced, and mixing of air bubbles in the adhesive can be also prevented.

According to the invention in the second aspect, in addition to the effect of the invention of the first aspect, since the coating adhesive is formed on the whole area of the bonded surface of the member, spread of the spreading adhesive can be smoothly performed on the whole area of the bonded surface of the member.

According to the invention in the third aspect, in addition to the effect of the invention of the first aspect, spread of the spreading adhesive can be smoothly performed in the area inside the edge portion of the bonded surface of the member, and protrusion of the adhesive from the edge portion of the member can be prevented.

### BRIEF DESCRIPTION OF THE DRAWINGS

FIGS. 1A to 1C are process charts illustrating Example 1 of a method for manufacturing a bonded member according to Embodiment 1 of the present invention.

FIGS. 2A to 2C are process charts illustrating Example 2 of the method for manufacturing a bonded member according to Embodiment 1 of the present invention.

FIGS. 3A to 3C are process charts illustrating Example 3 of the method for manufacturing a bonded member according to Embodiment 1 of the present invention.

FIGS. 4A to 4C are process charts illustrating Example 4 of the method for manufacturing a bonded member according to Embodiment 1 of the present invention.

FIGS. 5A to 5F are plan views illustrating examples of a shape of a spreading adhesive in Embodiment 1 of the present invention.

FIG. 6 is a perspective view illustrating an example of the shape of the spreading adhesive in Embodiment 1 of the present invention.

FIG. 7 is a perspective view illustrating another example of the shape of the spreading adhesive in Embodiment 1 of the present invention.

FIGS. 8A to 8C are process charts of a method for manufacturing a bonded member according to Embodiment 2 of the present invention.

FIGS. 9A and 9B are explanatory diagrams of a prior-art pressurizing type method for manufacturing a bonded member.

### DESCRIPTION OF THE EMBODIMENTS

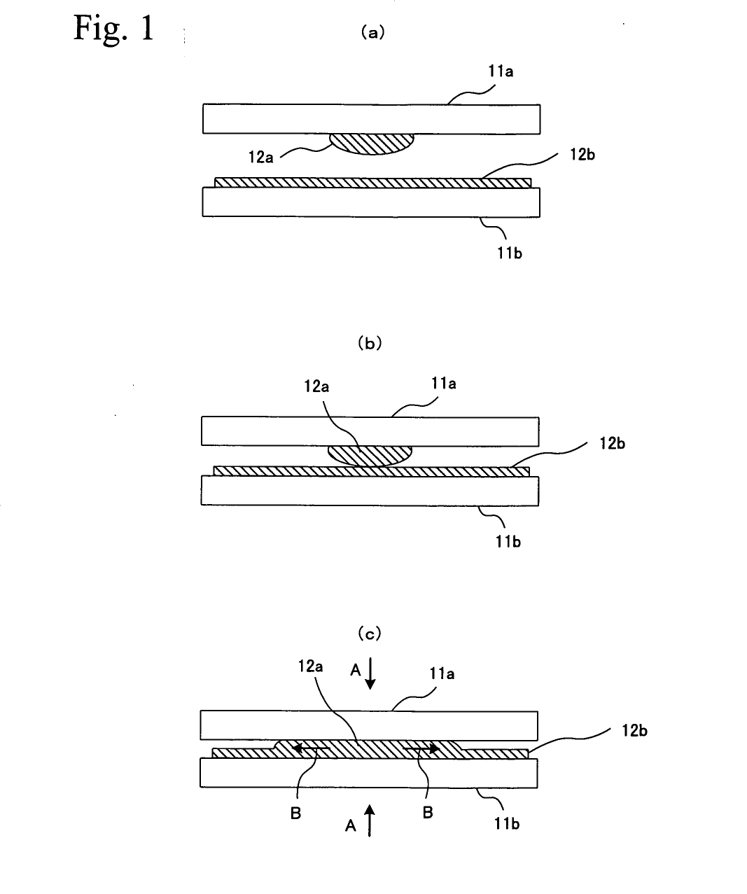

Embodiments of the present invention will be described below. FIGS. 1A to 1C are process charts illustrating Example 1 of a method for manufacturing a bonded member according to Embodiment 1 of the present invention. In this Example 1, a spreading adhesive is applied on one member 11a of two members 11a and 11b, and the surface of the other member 11b is coated with an adhesive. In the explanation below, the adhesive applied for spread is called a spreading adhesive 12a, while the adhesive coating the whole surface of the member is called a coating adhesive 12b.

Moreover, in the explanation below, a case in which, when the two members 11a and 11b are pressurized so as to spread the spreading adhesive 12a, a non-coated area required for preventing protrusion of the adhesive 12a from edge portions of the two members 11a and 11b is ensured, and the coating adhesive 12b of the other member 11b is formed on the surface of the other member 11b will be described. That is, the case where the coating adhesive 12b is applied on an area inside the edge portions of the bonded surfaces of the two members 11a and 11b will be described.

The coating adhesive 12b of the other member 11b may be applied on the whole area of the bonded surface of the member 11b instead of the area inside the edge portions of the bonded surfaces of the two members 11a and 11b. In this case, protrusion of the adhesive 12a from the edge portions of the two members 11a and 11b is prevented by adjusting a pressurizing force of the two members 11a and 11b.

Moreover, in the explanation below, a case in which an applied position of the spreading adhesive 12a is substantially at a center position between the one member 11a and the other member 11b, and the bonded surfaces of the one member 11a and the other member 11b are bonded by being faced with each other substantially in parallel will be described.

The bonded surfaces of the one member 11a and the other member 11b may be bonded with an angle using a hinge method, and the applied position of the spreading adhesive 12a does not have to be substantially at the center position between the one member 11a and the other member 11b. Particularly, if the one member 11a and the other member 11b are to be bonded with an angle by using the hinge method, the applied position of the spreading adhesive 12a is preferably on a portion closer to the axis of the hinge. That is because the portion closer to the axis of the hinge is pressurized first, and the pressurizing force becomes larger, and spread of a resin becomes larger from the axis side of the hinge to the opposite side of the axis.

As described above, the applied position of the spreading adhesive 15a does not necessarily have to be the center position between the one member 14a and the other member 14b depending on a method of pressurization.

First, in an adhesive applying process illustrated in FIG. 1A, the spreading adhesive 12a is applied on the one member 11a, while the coating adhesive 12b is applied to the other member 11b. Subsequently, the bonded surfaces of the member 11a on which the spreading adhesive 12a is applied and the member 11b on which the coating adhesive 12b is applied are faced with each other, and in a contact process illustrated in FIG. 1B, the spreading adhesive 12a is brought into contact with the coating adhesive 12b of the other member 11b.

Moreover, in a spreading process illustrated in FIG. 1C, the two members 11a and 11b are pressurized in an arrow A direction so as to spread the spreading adhesive 12a in an arrow B direction. In this case, the spreading adhesive 12a spreads on the surface of the member 11a and on the coating adhesive 12b of the member 11b. Friction on an interface between the spreading adhesive 12a and the coating adhesive 12b is smaller than friction on the interface between the spreading adhesive 12a and the surface of the member 11a and thus, the spreading adhesive 12a can spread more easily by a portion of the interface with the coating adhesive 12b than the case of only the interface with the surface of the member 11a, and spread of the spreading adhesive 12a between the two members 11a and 11b can be performed in a short time. Moreover, after the spreading adhesive 12a is brought into contact with the coating adhesive 12b and then, it spreads on the coating adhesive 12b and thus, mixing-in of air bubbles can be prevented.

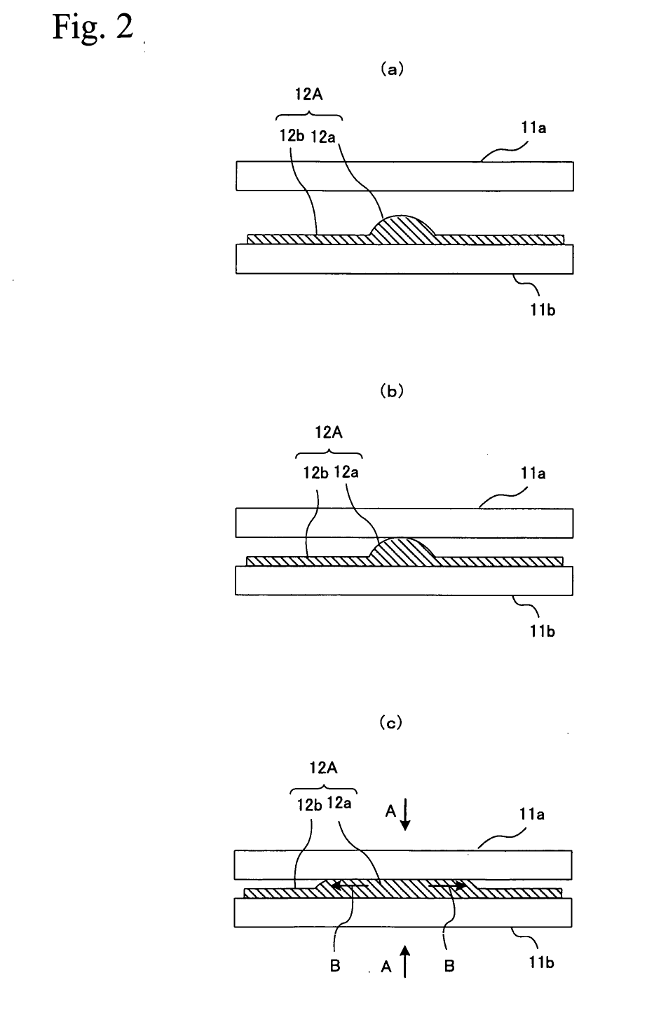

FIGS. 2A to 2C are process charts illustrating Example 2 of the method for manufacturing a bonded member according to Embodiment 1 of the present invention. In this Example 2, on the one member 11b of the two members 11a and 11b, a spreading adhesive also serving as a coating adhesive (coating/spreading adhesive) 12A is formed. The coating/spreading adhesive 12A is made of the spreading adhesive 12a and the coating adhesive 12b.

In the adhesive applying process in FIG. 2A, the coating/spreading adhesive 12A is applied on the member 11b. Then, the bonded surfaces of the member 11b on which the coating/spreading adhesive 12A is applied and the member 11a on which the adhesive 12 is not applied are faced with each other, and in the contact process illustrated in FIG. 2B, the spreading adhesive 12a of the coating/spreading adhesive 12A of the member 11b is brought into contact with the surface of the member 11a.

Moreover, in the spreading process in FIG. 2C, the two members 11a and 11b are pressurized in the arrow A direction so as to spread the spreading adhesive 12a of the coating/spreading adhesive 12A in the arrow B direction. In this case, the spreading adhesive 12a spreads on the surface of the member 11a and on the coating adhesive 12b of the member 11b. Therefore, similarly to the case of Example 1, the spreading adhesive 12a can easily spread, and spread of the spreading adhesive 12a between the two members 11a and 11b can be performed in a short time. Moreover, since the spreading adhesive 12a is brought into contact with the coating adhesive 12b and then, it spreads on the coating adhesive 12b, mixing-in of air bubbles can be prevented.

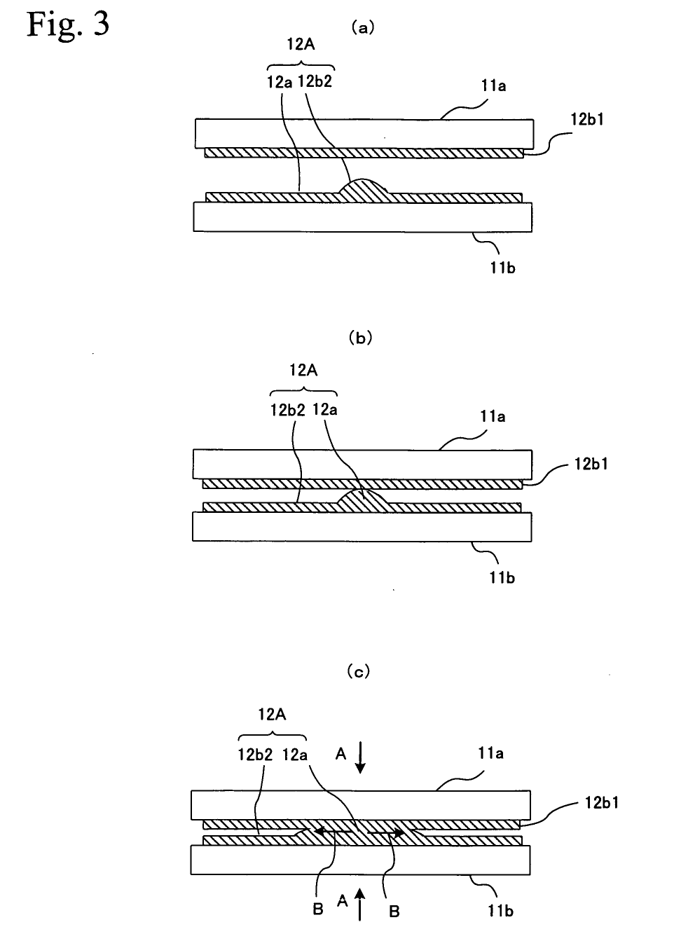

FIGS. 3A to 3C are process charts illustrating Example 3 of the method for manufacturing a bonded member according to Embodiment 1 of the present invention. In this Example 3, a coating adhesive 12b1 is formed on the one member 11a of the two members 11a and 11b, while the coating/spreading adhesive 12A made of the spreading adhesive 12a and a coating adhesive 12b2 is formed on the other member 11b.

In the adhesive applying process illustrated in FIG. 3A, the coating adhesive 12b1 is applied on the member 11a, and the coating/spreading adhesive 12A is applied on the member 11b. The spreading adhesive 12a is located on the coating adhesive 12b2.

Then, the bonded surfaces of the member 11a on which the coating adhesive 12b1 is applied and the coating/spreading adhesive 12A are faced with each other, and in the contact process illustrated in FIG. 3B, the spreading adhesive 12a of the coating/spreading adhesive 12A of the member 11b is brought into contact with the coating adhesive 12b1 of the member 11a.

Moreover, in the spreading process illustrated in FIG. 3C, the two members 11a and 11b are pressurized in the arrow A direction, and the spreading adhesive 12a of the coating/spreading adhesive 12A is spread in the arrow B direction. In this case, the spreading adhesive 12a of the coating/spreading adhesive 12A spreads on the coating adhesive 12b1 of the member 11a and on the coating adhesive 12b2 of the member 11b. Therefore, the spreading adhesive 12a can spread more easily than in the case of Examples 1 and 2, and spread of the spreading adhesive 12a between the two members 11a and 11b can be performed in a short time. Moreover, since the spreading adhesive 12a is brought into contact with the coating adhesive 12b and then, it spreads on the coating adhesive 12b, mixing-in of air bubbles can be prevented.

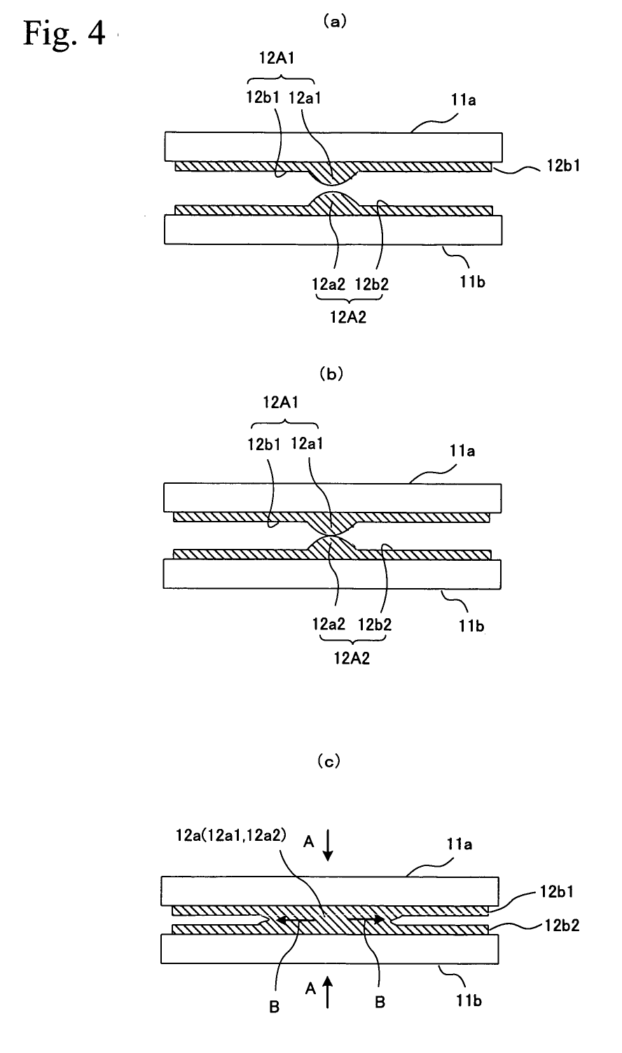

FIGS. 4A to 4C are process charts illustrating Example 4 of the method for manufacturing a bonded member according to Embodiment 1 of the present invention. In this Example 4, a coating/spreading adhesive 12A1 and a coating/spreading adhesive 12A2 are formed on both the two members 11a and 11b.

In the adhesive applying process illustrated in FIG. 4A, the coating/spreading adhesive 12A1 is applied on the member 11a, and the coating/spreading adhesive 12A2 is formed and applied on the member 11b. Spreading adhesives 12a1 and 12a2 are located on coating adhesives 12b1 and 12b2.

Then, the bonded surfaces of the member 11a on which the coating/spreading adhesive 12A1 is applied and the member 11b on which the coating/spreading adhesive 12A2 is applied are faced with each other, and in the contact process illustrated in FIG. 4B, the spreading adhesive 12a1 of the coating/spreading adhesive 12A1 of the member 11a is brought into contact with the spreading adhesive 12a2 of the coating/spreading adhesive 12A2 of the member 11b.

Moreover, in the spreading process illustrated in FIG. 4C, the two members 11a and 11b are pressurized in the arrow A direction, and the spreading adhesives 12a1 and 12a2 of the coating/spreading adhesives 12A1 and 12A2 are spread in the arrow B direction. In this case, the spreading adhesive 12a (12a1, 12a2) spreads on the coating adhesive 12b1 of the member 11a and the coating adhesive 12b2 of the member 11b. Therefore, the spreading adhesive 12a can spread more easily than in the case of Examples 1 and 2, and spread of the spreading adhesive 12a between the two members 11a and 11b can be performed in a short time. Moreover, since the spreading adhesive 12a is brought into contact with the coating adhesive 12b and then, it spreads on the coating adhesive 12b, mixing-in of air bubbles can be prevented.

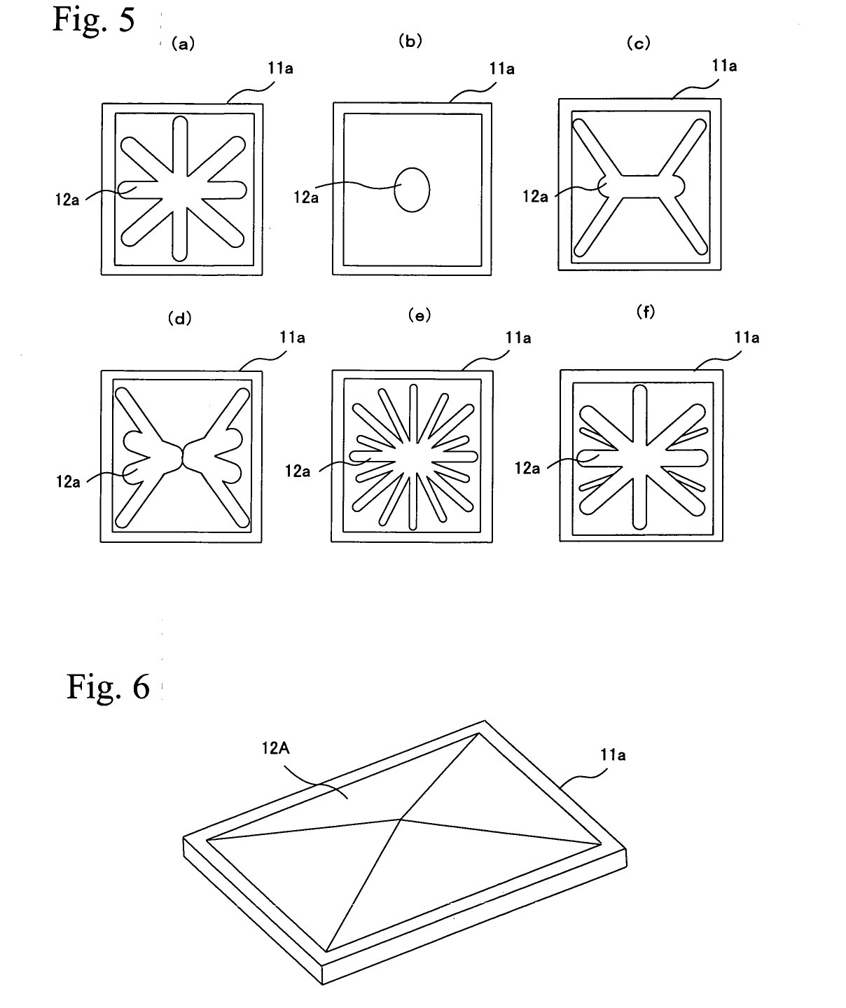

FIGS. 5A to 5F are plan views illustrating examples of the shape of the spreading adhesive 12a of the coating/spreading adhesive 12A. The spreading adhesive 12a of the coating/spreading adhesive 12A is formed by being applied so as to raise the adhesive on the one member 11a. FIG. 5A is a star shape, FIG. 5B is a center dot shape, FIG. 5C is a double-Y shape, FIG. 5D is a butterfly shape, FIG. 5E is a double-star shape, and FIG. 5F is a complex star shape (star+4). In any case, the adhesive spreads from the center part to the four directions in the shape.

FIG. 6 is a perspective view illustrating an example of the shape of the coating/spreading adhesive 12A. In this case, too, the spreading adhesive 12a is formed by applying so as to raise the adhesive on the one member 11a. In FIG. 6, a square pyramid shape (pyramid shape) having an apex at the center part and raised from corner parts of the square toward the apex is illustrated. As described above, by forming the coating/spreading adhesive 12A into a square pyramid shape having an apex at the enter part, the adhesive spreads substantially equally to the four directions from the center part, and therefore this shape is a preferable shape.

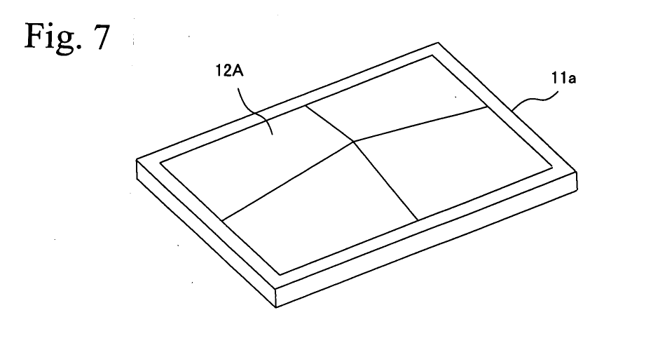

FIG. 7 is a perspective view illustrating another example of the shape of the coating/spreading adhesive 12A. In this case, a shape having an apex at the center part and formed into a pyramid raised from side parts of the square toward the apex is illustrated. In this case, too, since the pyramid shape is formed having an apex at the center part, the adhesive spreads substantially equally to the four directions from the center part. Therefore, this shape is a preferable shape.

Subsequently, the method for manufacturing a bonded member according to Embodiment 2 of the present invention will be described. In Embodiment 1 illustrated in FIGS. 1A to 4C, the spreading adhesive 12a of the coating/spreading adhesive 12A is brought into contact with the coating adhesive 12b and then, it spreads on the coating adhesive 12b and thus, mixing-in of air bubbles can be prevented. However, if wettability of the adhesive or member is low, air bubbles might be mixed in between the adhesives 12 or between the adhesive 12 and the surface of the member 11 during contact (wetting) between the adhesive and the adhesive or during contact (wetting) between the adhesive and the member. This is because, if wettability of the adhesive is low, even if the spreading adhesive 12a is brought into contact with the coating adhesive 12b or the member 11, they do not blend with each other immediately.

Thus, in order to prevent mixing-in of air bubbles more reliably, in Embodiment 2 of the present invention, a voltage is intermittently applied between the two members 11a and 11b. By intermittently applying the voltage, a wetted part is generated only at one spot where the distance is the shortest and then, pressurization is performed so as to prevent generation of air bubbles by surrounding.

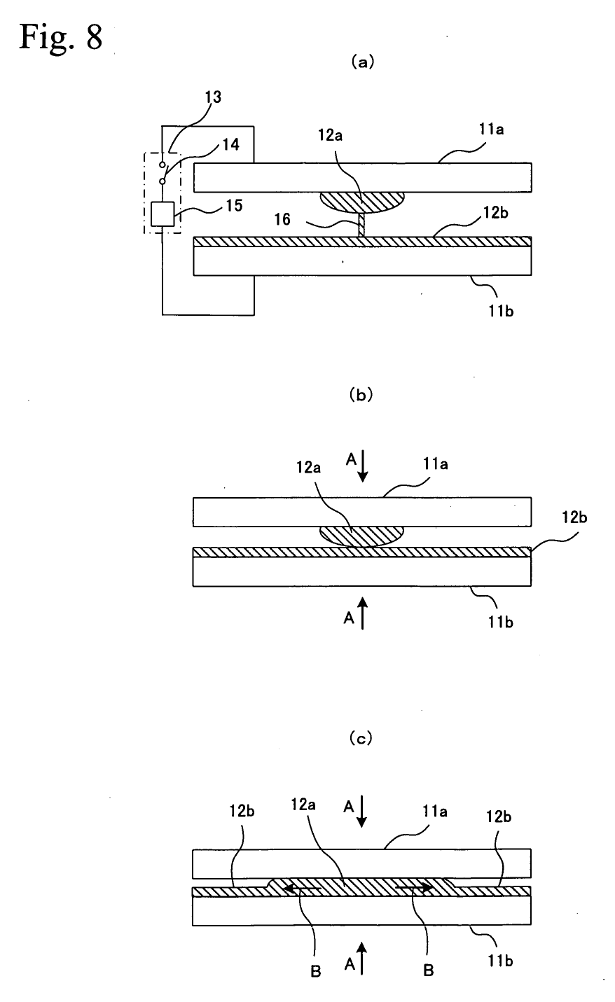

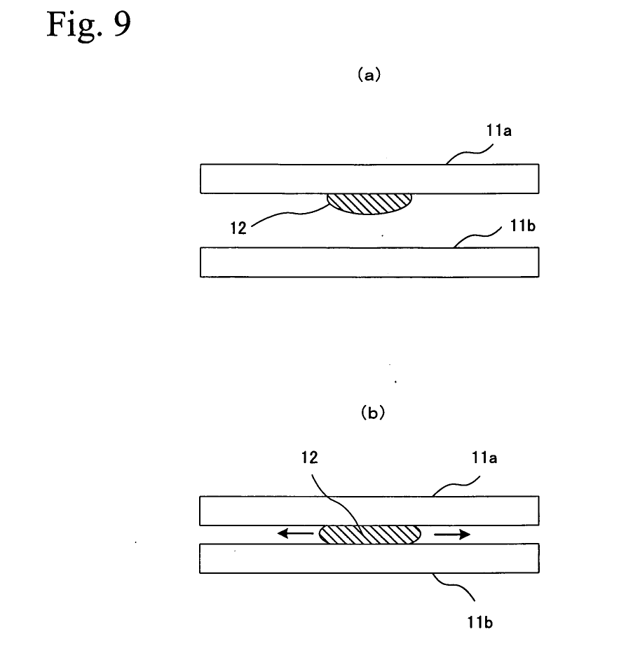

FIGS. 8A to 8C are process charts of the method for manufacturing a bonded member according to Embodiment 2 of the present invention. In this Embodiment 2, the spreading adhesive 12a is applied by being raised on the one member 11a of the two members 11a and 11b, while the coating adhesive 12b is formed on the other member 11b.

First, as illustrated in FIG. 8A, a voltage is intermittently applied between the two members, that is, the member 11a and the member 11b from a voltage applying device 13. This is performed by intermittently turning on/off a switch 14 of the voltage applying device 13. As a result, a wetted part 16 is generated only at one spot between the spreading adhesive 12a and the coating adhesive 12b where the distance is the shortest.

Then, as illustrated in FIG. 8B, the two members 11a and 11b are pressurized in the arrow A direction, the spreading adhesive 12a is brought close to the coating adhesive 12b on the basis of the wetted part 16 between the spreading adhesive 12a and the coating adhesive 12b, and the spreading adhesive 12a is brought into contact with the coating adhesive 12b.

Moreover, as illustrated in FIG. 8C, the two members 11a and 11b are pressurized in the arrow A direction, and the spreading adhesive 12a is spread in the arrow B direction. In this case, the spreading adhesive 12a spreads on the surface of the member 11a and on the surface of the coating adhesive 12b.

As described above, in Embodiment 2 of the present invention, a voltage is intermittently applied between the two members 11a and 11b. By intermittently applying the voltage, a charge accumulated between the adhesive 12b of the member 11b and the member 11a is temporarily discharged, and as a result, the wetted part 16 is generated only at one spot where the distance is the shortest. Since the wetted part 16 is formed on one spot and bonding is performed based on that, air bubbles are not generated in a contact portion between the spreading adhesive 12a and the coating adhesive 12b, and generation of air bubbles by surrounding can be prevented.

Some embodiments of the present invention have been described, but these embodiments are presented as examples and are not intended to limit the scope of the invention. These new embodiments can be put into practice in the other various forms and are capable of various omission, replacement and changes within a range not departing from the gist of the invention. These embodiments and their variations are included in the scope and the gist of the invention and are also included in the invention described in the appended claims and their equivalent range.

What is claimed is:

1. A method for manufacturing a bonded member, comprising steps of:
coating a predetermined area of at least either one of bonded surfaces of two members with an adhesive and applying a spreading adhesive on at least either one of the bonded surfaces of the two members;
causing the two members to face each other while keeping a distance between the bonded surfaces thereof and intermittently applying a voltage between the two members;
after allowing the adhesive to be wetted at one spot on the bonded surface of the other member, bringing the spreading adhesive into contact with a coating adhesive on the other member or the other member; and
pressurizing the two members so as to spread the spreading adhesive and bonding the two members so as to manufacture a bonded member.

2. The method for manufacturing a bonded member according to claim 1, wherein
the predetermined area coated with the adhesive is the whole area of the bonded surface of the member.

3. The method for manufacturing a bonded member according to claim 1, wherein
the predetermined area coated with the adhesive is, when the two members are pressurized and the spreading adhesive is spread, an area inside an edge portion of the bonded surface of the member in which a non-coated area required for preventing protrusion of the adhesive from the edge portion of the member is ensured.
